(19) United States
(12) Patent Application Publication
(10) Pub. No.: US 2006/0245224 A1
(43) Pub. Date: Nov. 2, 2006

(54) Semiconductor power module package

(75) Inventors: Ian Hsieh, Hsinchu City (TW); Vincent Tsao, Yonghe City (TW)

Correspondence Address: BRUCE H. TROXELL, SUITE 1404, 5205 LEESBURG PIKE, FALLS CHURCH, VA, 22041, US

(73) Assignee: Holtek Semiconductor Inc.

(21) Appl. No.: 11/149,255

(22) Filed: Jun. 10, 2005

(30) Foreign Application Priority Data
Apr. 29, 2005 (TW) 94113831

(51) Int. Cl. H02M 1/00

(52) U.S. Cl. 363/147

(57) ABSTRACT

A power module disclosed in the invention has a controller chip and a power chip disposed on a same die pad, which can be a standard die pad commonly seen in the industry so that a extra cost of making and designing a die pad especially for the power module can be saved. Moreover, since the controller chip can use a manufacturing process different than that of the power chip, the overall size of the power module of the invention is minimized by adopting two optimal manufacturing processes respective for making the controller chip and the power chip as small as possible.

### FIELD OF THE INVENTION

The present invention relates to a package for power module, and more particularly, to a power module package using only a single die pad.

### BACKGROUND OF THE INVENTION

Please refer to FIG. 1, which is a schematic view of a conventional power module package. The prior-art power module 100 shown in FIG. 1, being encapsulated in an insulating body 110, is primarily consisted of two die pads 120, 130, a controller chip 140, a power chip 150, two leads 160, 170 and two paddles 125, 135 extending respectively from the two corresponding die pad 140, 150.

Wherein, the controller chip 140 and the power chip 150 are arranged on the two die pads 120, 130 in respective while allowing signals to be transmitted between the controller chip 140 and the power chip 150, and signals to be transmitted from the controller chip 140 and the power chip 150 respectively to the leads 160, 170 and then out of the insulating body 110, all by way of a bonding wire assembly 180.

In the conventional backlight module,

The prior-art power module 100 is characterized in that: by placing the controller chip 140 and the power chip 150 are arranged on the two die pads 120, 130 in respective, the control chip 140 and the power chip can be supported with potentials independent to each other such that the power module 100 is capable of providing a comparatively larger power output.

However, it is also because of the control chip 140 and the power chip being placing on the two independent die pads 120, 130 in respective while requiring the die pads 120, 130 to be respectively designed and manufactured specifically with respect to match the size of the controller chip 140 and the power chip 150, the overall cost of the power module 100 is high.

Moreover, with the design trend of electronic products moving toward lighter, thinner and smaller, there are increasing need to have a semiconductor power module that can be packed in a package as small as possible while being capable of outputting sufficient power.

Therefore. The present invention proposes a power module package, having package size and manufacturing cost being effectively reduced while being capable of outputting sufficient power.

### SUMMARY OF THE INVENTION

In view of the disadvantages of prior art, it is the primary object of the present invention to provide a power module package, having package size and manufacturing cost being effectively reduced while being capable of outputting sufficient power.

To achieve the above object, the present invention provides a power module package, being encapsulated in an insulating body and employing a plurality of leads as terminals of signal input/output, the power module package comprising: a die pad; a controller chip, arranged on the die pad; and at least a power chip, each being arranged on the die pad at a position next to the controller chip; wherein the signal transmission between the controller chip, the power chip and the plural leads is enabled by a wire assembly bonded therebetween.

In a preferred embodiment of the invention, the manufacturing processes of the controller chip and the power chip are different, that is, the controller chip adopts a low-voltage, low-current process while the power chip adopts a high-voltage, high-current process. For instance, the power chip can be a metal-oxide-semiconductor field effect transistor (MOSFET) chip, or a bipolar junction transistor (BJT) chip, or a chip a chip integrating a MOSFET and a BJT. By virtue of this, the overall package size and the manufacturing cost are reduced.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic view of a conventional power module package.

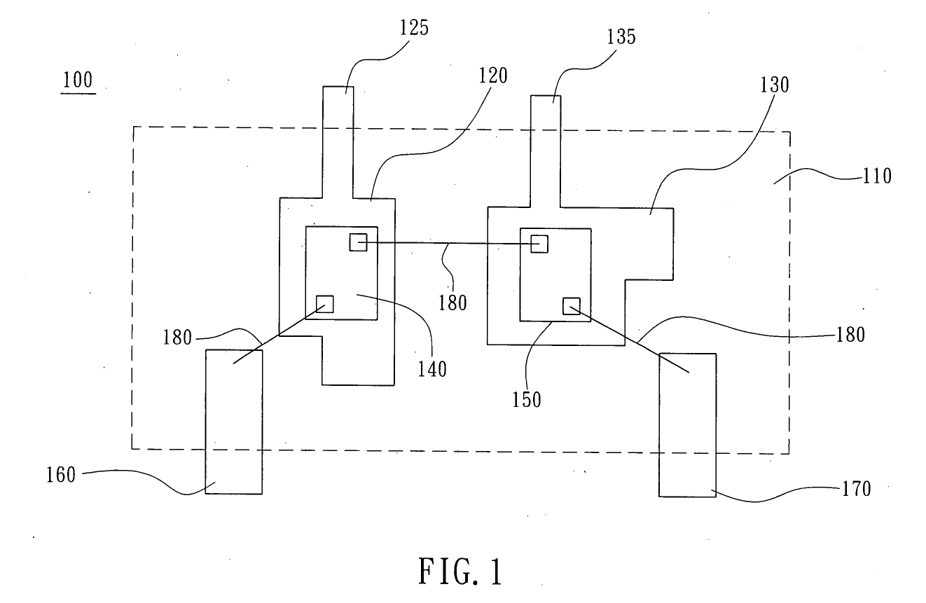

FIG. 2 is a schematic view of a power module package according to a preferred embodiment of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

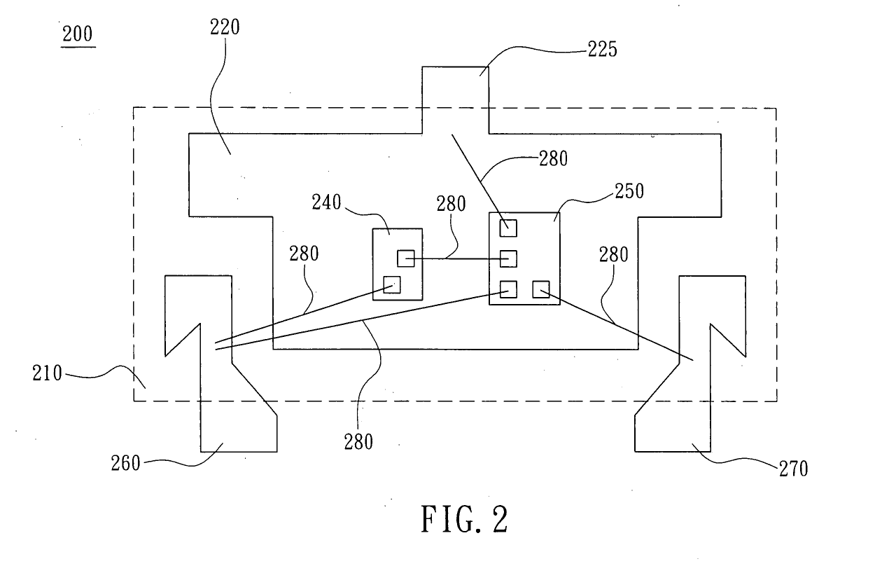

Please refer to FIG. 2, which is a schematic view of a power module package according to a preferred embodiment of the invention. As seen in FIG. 2, the power module 200 is encapsulated in an insulating body 210, which is primarily consisted of a die pad 220, a controller chip 240, and at least a power chip 250; wherein, the die pad includes a paddle 225 and two leads 260, 270.

In the preferred embodiment shown in FIG. 2, the paddle 225 is coupled to a power source (Vdd), and the signal transmission among the controller chip 240, the power chip 250 and the leads 260, 270 is enabled by a wire assembly 280 bonded therebetween which is further being outputted through the two leads 260, 270.

Moreover, since the controller chip 240 and the power chip 250 are arranged on the same die pad 220, the manufacturing process adopted by the controller chip 240 can be different than that of the power chip 250. The reasoning is that: the power chip 150, being a integrated power driving circuit, is the primary operating circuit of the power module 200 that should be able to sustain high voltage and high current. Therefore, a high-voltage high-current manufacturing process should be adopts for making the power chip 250. On the other hand, the controller chip 240, being a integrated digital logic control circuit, is not required to sustain high voltage and high current during operation. Hence, a low-voltage low-current manufacturing process can be adopts for making the controller chip 240.

By virtue of this, as the manufacturing process adopted by the controller chip 240 is different than that of the power chip 250 while the controller chip 240 employing a low-voltage low-current manufacturing process should be able to have a smaller size than that of the power chip 250 employing a high-voltage high-current manufacturing process, the overall size of the power module 200 can be reduced effectively under the current package technology as two optimal manufacturing processes are adopted respectively for making the controller chip 240 and the power chip 250 as small as possible.

In this preferred embodiment shown in FIG. 2, the power chip can be a P-channel MOSFET chip, a N-channel MOSFET chip, a BJT chip, or a BiCMOS, and so on. In addition, a non-conductive adhesive or a conductive adhesive can be adopts for attaching either the power chip 250 or the controller chip 240 on the die pad 220, which are selected according to design requirements. That is, if a design of the power module 200 requires the bottom of the power chip 250 to be electrically connected to the die pad 220, either the conduction is realized by using the conductive adhesive or can be realized by using a wire assembly to enable the bottom signals of the power chip 250 to be transmitted to the die pad 220 while the non-conductive adhesive is adopts for attaching the power chip 250. Moreover, the above description is also true for the controller chip 240.

In another preferred embodiment, the amount of leads used in the power module can be increased/reduced for matching the amount of signals outputted from the controller chip 240 and the power chip 250.

The advantage of the power module of the invention is listed as following:
(a) Since the controller chip and the power chip are disposed on a same die pad, a standard die pad commonly seen in the industry is sufficient for the power module of the invention and thus a extra cost of making and designing a specific die pad especially for the power module can be saved, such that the overall cost of the power module of the invention is less than that of prior arts.
(b) As the manufacturing process adopted by the controller chip 240 is different than that of the power chip 250 while the controller chip 240 employing a low-voltage low-current manufacturing process should be able to have a smaller size than that of the power chip 250 employing a high-voltage high-current manufacturing process, the overall size of the power module 200 can be reduced effectively under the current package technology as two optimal manufacturing processes are adopted respectively for making the controller chip 240 and the power chip 250 as small as possible.
(c) A non-conductive adhesive or a conductive adhesive can be adopts for attaching either the power chip or the controller chip on the die pad, which are selected according to design requirements.

To sum up, the present invention provides a power module having a controller chip and a power chip disposed on a same die pad, which can be a standard die pad commonly seen in the industry so that a extra cost of making and designing a specific die pad for the power module can be saved. Moreover, since the controller chip can use a manufacturing process different than that of the power chip, the overall size of the power module of the invention is minimized by adopting two optimal manufacturing processes respectively for making the controller chip 240 and the power chip 250 as small as possible.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A semiconductor power module package, being encapsulated in an insulating body and employing at least two leads and a paddle as input/output terminals, the power module package comprising:
a die pad, having the paddle attached thereto;
a controller chip, each being adhered to the die pad by a non-conductive adhesive; and
at least a power chip, being adhered to the die pad by a non-conductive adhesive at a position next to the controller chip;
wherein the signal transmission among the controller chip, the power chip and the plural leads is enabled by a wire assembly bonded therebetween; and the manufacturing process adopted by the controller chip is different than that of the power chip.

2. The semiconductor power module package of claim 1, wherein the power chip is a metal-oxide-semiconductor field effect transistor chip.

3. The semiconductor power module package of claim 1, wherein the power chip is a bipolar junction transistor chip.

4. The semiconductor power module package of claim 1, wherein the power chip is a chip integrating a metal-oxide-semiconductor field effect transistor and a bipolar junction transistor.

5. The semiconductor power module package of claim 1, wherein the bottom signals of the controller chip and the power chip are transmitted to the die pad and the specific leads by using a wire assembly.

6. A semiconductor power module package, being encapsulated in an insulating body and employing at least two leads and a paddle as input/output terminals, the power module package comprising:
a die pad;
a controller chip, each being adhered to the die pad by a conductive adhesive; and
at least a power chip, being adhered to the die pad by a conductive adhesive at a position next to the controller chip;
wherein the signal transmission among the controller chip, the power chip and the plural leads is enabled by a wire assembly bonded therebetween; and the manufacturing process adopted by the controller chip is different than that of the power chip.

7. The semiconductor power module package of claim 6, wherein the power chip is a metal-oxide-semiconductor field effect transistor chip.

8. The semiconductor power module package of claim 6, wherein the power chip is a bipolar junction transistor chip.

9. The semiconductor power module package of claim 6, wherein the power chip is a chip integrating a metal-oxide-semiconductor field effect transistor and a bipolar junction transistor.

10. A semiconductor power module package, being encapsulated in an insulating body and employing at least two leads and a paddle as input/output terminals, the power module package comprising:
a die pad;
a controller chip, each being adhered to the die pad by a non-conductive adhesive; and
at least a power chip, being adhered to the die pad by a conductive adhesive at a position next to the controller chip;
wherein the signal transmission among the controller chip, the power chip and the plural leads is enabled by a wire assembly bonded therebetween; and the manufacturing process adopted by the controller chip is different than that of the power chip; and the bottom signals of the controller chip are transmitted to the die pad and the specific leads by using a wire assembly.

11. The semiconductor power module package of claim 10, wherein the power chip is a metal-oxide-semiconductor field effect transistor chip.

12. The semiconductor power module package of claim 10, wherein the power chip is a bipolar junction transistor chip.

13. The semiconductor power module package of claim 10, wherein the power chip is a chip integrating a metal-oxide-semiconductor field effect transistor and a bipolar junction transistor.

14. A semiconductor power module package, being encapsulated in an insulating body and employing at least two leads and a paddle as input/output terminals, the power module package comprising:
a die pad;
a controller chip, each being adhered to the die pad by a conductive adhesive; and
at least a power chip, being adhered to the die pad by a non-conductive adhesive at a position next to the controller chip;
wherein the signal transmission among the controller chip, the power chip and the plural leads is enabled by a wire assembly bonded therebetween; and the manufacturing process adopted by the controller chip is different than that of the power chip; and the bottom signals of the power chip are transmitted to the die pad and the specific leads by using a wire assembly.

15. The semiconductor power module package of claim 14, wherein the power chip is a metal-oxide-semiconductor field effect transistor chip.

16. The semiconductor power module package of claim 14, wherein the power chip is a bipolar junction transistor chip.

17. The semiconductor power module package of claim 14, wherein the power chip is a chip integrating a metal-oxide-semiconductor field effect transistor and a bipolar junction transistor.
